(19) United States
(12) Patent Application Publication
(10) Pub. No.: US 2017/0226802 A1
(43) Pub. Date: Aug. 10, 2017

(54) TANK CAR ACCESS LADDER

(71) Applicant: Transco Railway Products, Inc., Chicago, IL (US)

(72) Inventors: Joseph Click, Warren, OH (US); David Cline, Canfield, OH (US)

(21) Appl. No.: 15/018,489

(22) Filed: Feb. 8, 2016

(51) Int. Cl. E06C 1/34; B61D 49/00; B60R 3/00

(52) U.S. Cl. CPC E06C 1/34; B60R 3/007; B61D 49/00

(57) ABSTRACT

A portable ladder having a pair of elongate stiles spaced from one another and each having first and second ends, and extending in a first direction; and a plurality of rungs each extending between the elongate stiles transverse to the first direction and having opposed ends one of each attached to each of the elongate stiles and each of the plurality of rungs being spaced from one another along the first direction, the rungs being arcuate in shape between the opposed ends.

### FIELD OF THE INVENTION

A portable ladder having arcuate rungs and is deployable through a hatchway of a tank.

### BACKGROUND OF THE INVENTION

Tanks for containing liquids are often mounted on a railcar, a semi-trailer, or other vehicle for transporting liquids, often in large volumes. Human access to the tank is provided through a hatchway on a top of the tank. The vertical distance from the hatchway to a bottom wall of the tank can be large enough to require a ladder to safely traverse this distance. The inner chamber of a tank must be accessed, from time to time, for cleaning, inspection and maintenance. Accordingly, the present invention provides a ladder that can be deployed through the hatchway of the tank and secured thereto for safe access and removed upon exit from the tank.

### SUMMARY OF THE INVENTION

A portable ladder is disclosed having a pair of spaced elongate stiles extending generally parallel to one another and connected together by a plurality of rungs extending along a line generally perpendicular to the stiles and spaced from one another along a length of the stiles. The rungs extend along an arcuate path from one opposed end to another.

### BRIEF DESCRIPTION OF THE DRAWINGS

FIG. 1 is a perspective view of a ladder secured to a hatchway;

FIG. 2 is a side elevation view of the ladder of FIG. 1;

FIG. 3 is a top view of the ladder of FIG. 1 mounted on a hatchway;

FIG. 4 is a bottom view of the ladder of FIG. 1 mounted on a hatchway;

FIG. 5 is a front view of a multi-piece ladder assembly;

FIG. 6 is a front view of another embodiment of a one-piece ladder;

FIG. 7 is a perspective view of another embodiment of a ladder;

FIG. 8 is a front view of the ladder of FIG. 7;

FIG. 9 is a bottom view of the ladder of FIG. 7 mounted on a hatchway;

FIG. 10 is a front view of another embodiment of a multi-piece ladder assembly;

FIG. 11 is a perspective view of a ladder viewed from a top end;

FIG. 12 is a perspective view of a ladder viewed from a bottom; and

FIG. 13 is a perspective view of a front face of a ladder in a deployed condition.

### DETAILED DESCRIPTION

While this invention is susceptible of embodiment in many different forms, there is shown in the drawings, and will be described herein in detail, specific embodiments thereof with the understanding that the present disclosure is to be considered as an exemplification of the principles of the invention and is not intended to limit the invention to the specific embodiments illustrated.

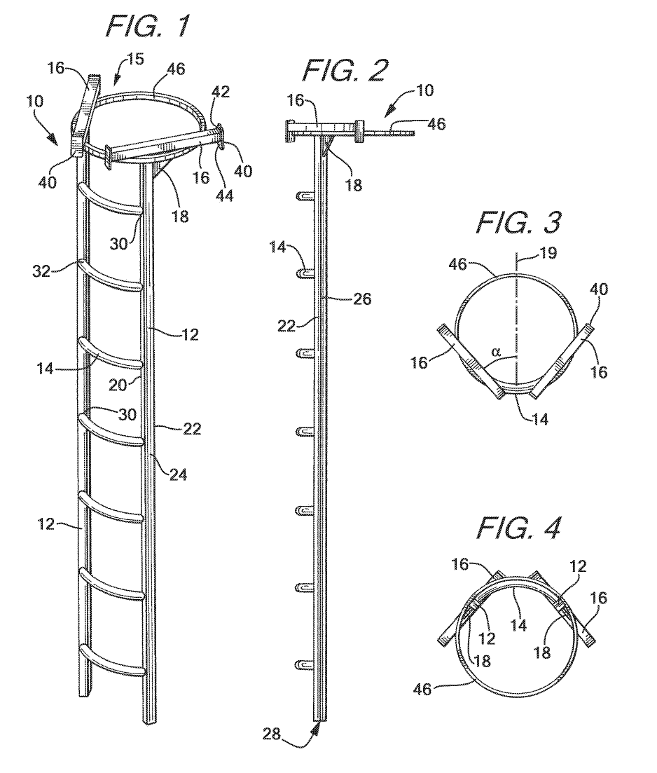

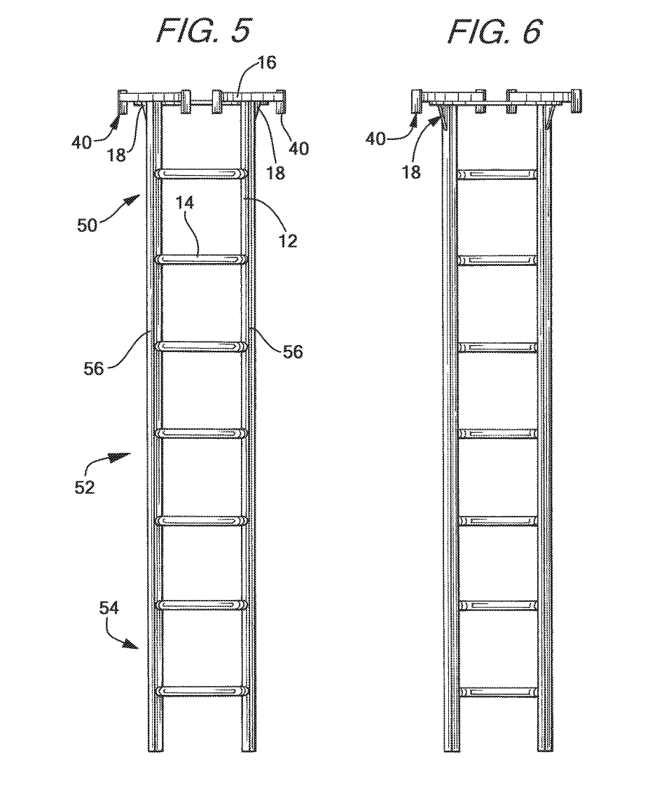

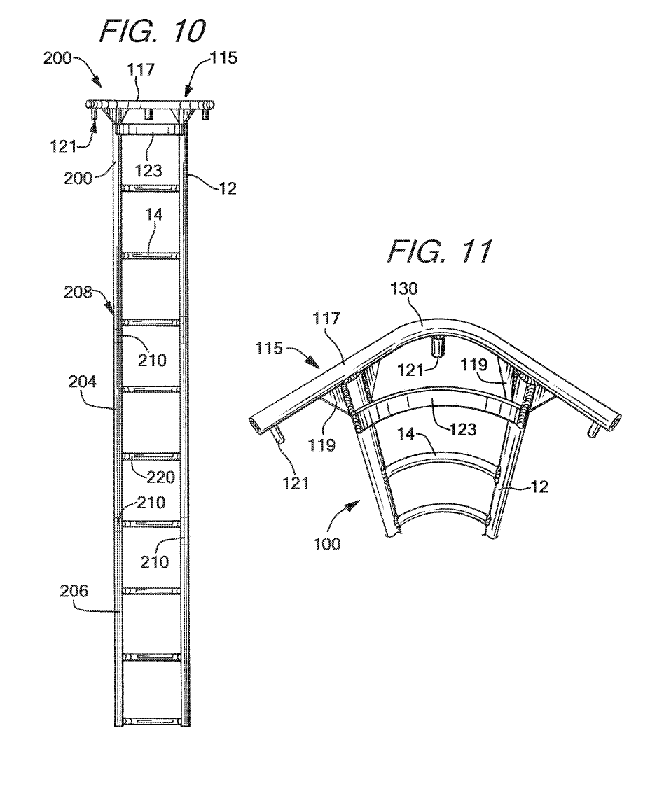

FIG. 1 shows a ladder 10 in an upright position having a pair of horizontally spaced stiles 12 extending vertically in parallel spaced relationship and a plurality of rungs 14 vertically spaced from one another and extending between and connecting the stiles. The ladder has a member or an assembly 15 for securing the ladder to a hatchway 46 of a tank. In one preferred form of the invention, the securing assembly 15 has a pair of arms 16, one of each, attached to a top end of each stile and forms an angle α (FIG. 3) on opposite sides of a plane 19 extending along a centerline of the ladder. The angle α is from about 25° to about 60°, more preferably from about 30° to about 45°, and most preferably about 30°. In a preferred form of the invention, a gusset 18 connects an arm 16 to a stile 12. In some embodiments, the ladder 10 will be assembled from separate parts for use (FIGS. 5 and 10) and can be disassembled for storage, for example. In another embodiment, the ladder will be sectionalized for ease of storage and portability. In yet another preferred form of the invention, the ladder will be fully assembled for use (FIGS. 1,6 and 8) and cannot be disassembled without damaging or destroying the ladder.

The stiles are elongate, having a length dimension greater than a width and a depth dimension, and can have a variety of shapes in horizontal cross section such as a straight line, a curved line, a letter shape, a C-shape, a D-shape, an H-shape, a T-shape, an L-shape, a V-shape, circular, oval, polygonal, irregular, and sinusoidal. Polygonal shapes include triangular, square, rectangular, trapezoidal, pentagonal, hexagonal, heptagonal, and octagonal. Most preferably, the stile is a square tube having an inner face 20, an outer face 22, a front face 24, a back face 26 and defines an inner channel 28. The inner face 22 has a plurality of spaced holes 30 dimensioned to receive an end portion 32 of a rung 14. The hole preferably extends through the entire thickness of the stile 12, and the end portion 32 of the rung will be permanently affixed to the stile by a weld, solder joint, adhesive, bracket or fastener. The hole 32 can also extend through the front face and the back face and the end portion of the rung can be permanently affixed to the front face, back face, or both. The inner channel 28 can be empty or can be filled with a lightweight material such as a foamed polystyrene, foamed polypropylene, or other material, to provide sound dampening, strength and increase buoyancy. In another form of the invention, the rungs will be attached directly to the inner face 20 (no holes 30) by weld, solder joint, adhesive, or indirectly through a bracket, or collar, or through both direct and indirect connections.

The rungs are elongate, having a length dimension greater than a width, a depth dimension or a diameter, and can also have a variety of shapes in cross section such as a straight line, a curved line, a C-shape, a D-shape, an H-shape, a T-shape, an L-shape, a V-shape, circular, oval, polygonal, irregular, and sinusoidal. Polygonal shapes include triangular, square, rectangular, trapezoidal, pentagonal, hexagonal, heptagonal, and octagonal. Most preferably, the rungs will have a circular shape in cross section. The rungs have an arcuate shape and a radius of curvature from one end to the other end. In a preferred form of the invention the radius of curvature of about 15¼ inches for a rung 12⅞ inches long. A portion 36 of each rung 14 extends outward beyond the outer face 22 of the stiles.

The arms 16 are elongate, having a length dimension greater than a width dimension, a depth dimension or a diameter, and can have a variety of shapes in cross section such as a straight line, a curved line, a C-shape, a D-shape, an H-shape, an L-shape, a V-shape, circular, oval, polygonal, irregular, and sinusoidal. Polygonal shapes include triangular, square, rectangular, trapezoidal, pentagonal, hexagonal, heptagonal, and octagonal. In one preferred form of the invention, the arms will have a square shape in cross section (FIGS. 1-6). In another preferred form of the invention, the arms will have end caps 40 attached to each end of the arms and will have an upper and lower flanges 42, 44, respectively, to serve as stops to prevent or reduce the tendency for the ladder to slip or move when mounted to a hatchway structure such as the hoop structure 46 shown in the figures.

The gusset 18 preferably is generally three sided and preferably is triangular in shape and preferably in the form of a right triangle. One leg of the triangle will be permanently attached to a portion of the outer face 22 and extend at the same angle α or parallel to the arm and will have a second leg permanently attached to a bottom portion of the arm. The term permanently affixed or attached includes a connection by a weld, solder joint, adhesive, bracket or fastener.

FIG. 5 shows a ladder that is assembled from three parts, an upper part 50, a middle part 52, and an lower part 54. The upper part 50 has the arms 16 connected thereto at an upper end and has a joint 56 on a lower end of each stile 12 for removably connecting to an upper end of the middle part 52. In one preferred form of the invention the joint will include a pair of holes on one of each stile of the upper part that are brought into alignment with a pair of holes, one of each on a stile of the middle part, the holes extending through the width or depth dimension of the stile and being dimensioned to receive a pin or bolt to secure the parts together. In one embodiment, the pin will have a hole dimensioned to receive a cotter, hairpin cotter, quick release pins or the like, for example. Quick release pins typically have a generally cylindrical shaft with a spring-loaded ball at a distal end of the shaft and a ring grip at an opposed end. The ball springs inward during installation and then pops out to lock the pin in place. The middle part 52 is connected to the lower part 54 in similar fashion to removably fasten the parts together. In a preferred form of the invention, the middle part and the lower part will be interchangeable by having joints for connecting at both ends. While, the ladder shows three pieces, this is merely to demonstrate a ladder that can be assembled by separate parts and it is contemplated the ladder can be assembled from fewer or greater number of parts without departing from the present invention.

While FIG. 5 shows a means for connecting ladder parts together with bolts and pins at joints 56, these joints 56 can alternatively include pivoting connecting members, such as hinges that allow the parts to be folded on top of one another so the length dimension of the ladder can be shortened or minimized for storage. Further, the dimensions of the stiles can be such that inner chamber 28 of the upper section 50 will be dimensioned to receive a portion of the middle part and likewise the middle part can have its inner chamber dimensioned to receive a portion of the lower section in telescoping fashion to reduce or adjust the length dimension of the ladder. Appropriate mechanisms will be provided to removably lock the respective ladder parts together while in use and to allow the ladder sections to slide with respect to one another during collapsing of the ladder for storage.

FIG. 6 shows a ladder that is fully assembled with the principal parts permanently connected together. While it may be possible to remove the end caps from the arms without destroying the ladder, most other connections will require the use of a tool to disconnect the parts and may even require damaging or destroying the part or parts altogether.

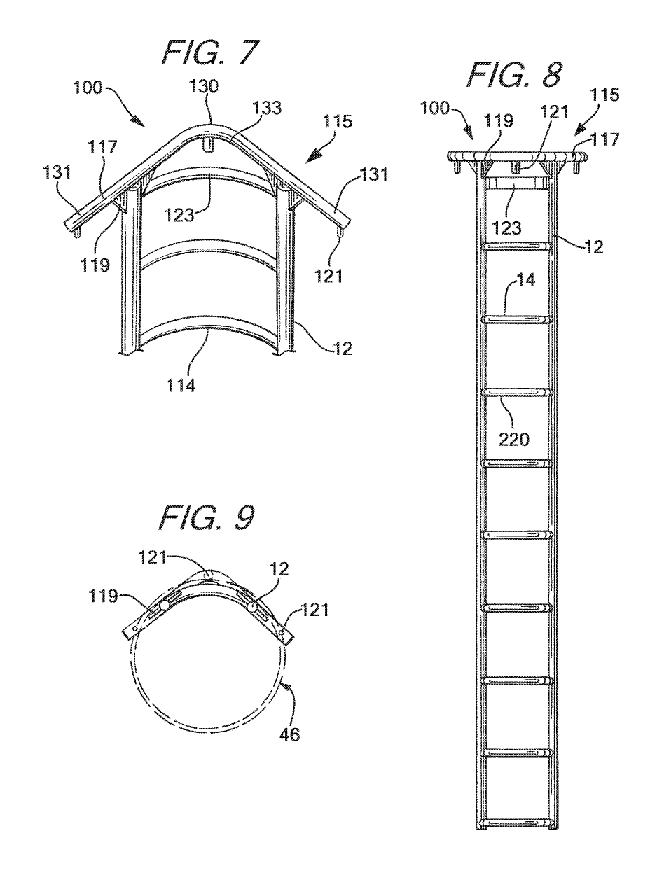

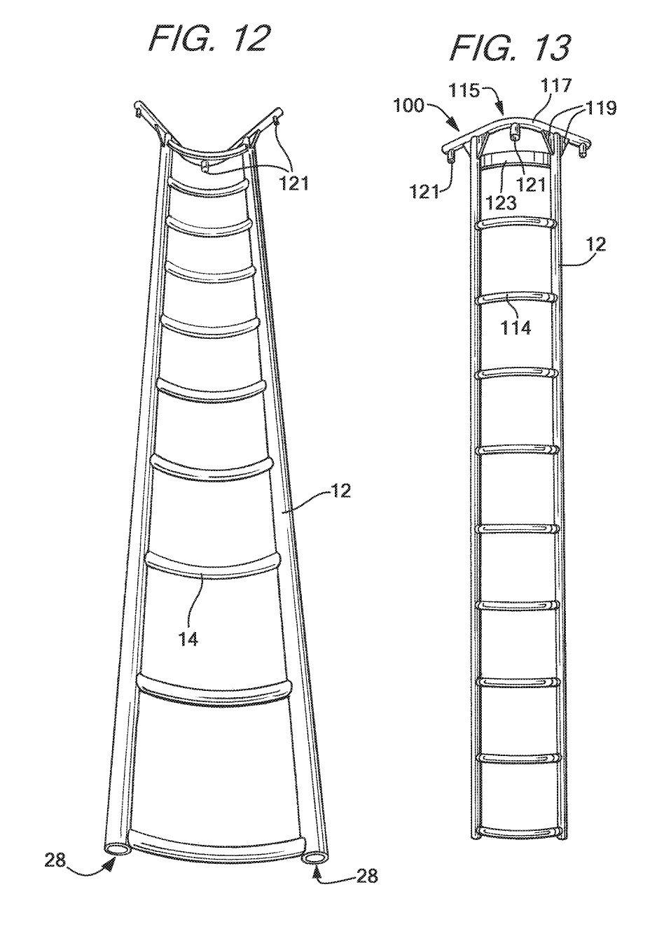

FIGS. 7-10 and 11-13 show another embodiment of a ladder 100 that differs from the embodiments discussed above with reference to FIGS. 1-6 by having stiles and rungs that are circular in horizontal cross section and has a securing assembly 115 that connects the stiles. In most other respects the embodiments are the same and like parts will be referred to with like numbers. The securing assembly 115 has a support bar 117, four gussets 119, three pins 121 and a strap 123. The securing assembly 115 connects a top end of each of the stiles and portions of the support bar extend beyond a vertical plane running through a center of the stiles to form flanges for mounting the ladder to the hatchway 46. The securing assembly can be fully assembled and then attached as a single unit to the two stiles or it can be attached to the stiles in separate pieces or subassemblies. Preferably, the securing assembly is permanently attached to the stiles by welding, soldering, brazing or other techniques well known to those of skill in the art. It is also contemplated that the securing assembly 115 can be removably attached to the stiles in the same manner used to connect stiles together as described above in reference to FIG. 5 for a multi-piece ladder assemblage.

The support bar 117 can have a variety of shapes in horizontal cross section such as a straight line, a curved line, a C-shape, a D-shape, an H-shape, an L-shape, a V-shape, circular, oval, polygonal, irregular, and sinusoidal. Polygonal shapes include triangular, square, rectangular, trapezoidal, pentagonal, hexagonal, heptagonal, and octagonal. In one preferred form of the invention, the support bar will have a circular shape in horizontal cross section. Additionally, in a preferred form of the invention, the support bar 117 will be arcuate in shape between opposed ends and will have a centrally disposed curved section 130. The support bar has two sections that extend beyond the stiles located at opposed ends of the support bar to form mounting flanges 131. The curved section also extends beyond the stiles and forms a third mounting flange 133.

In a preferred form of the invention, the gussets 119 are generally triangular and more preferably right triangles and connect a bottom surface of the support bar 117 to an outer surface of the stiles. Preferably, each pair of the gussets 119 is permanently attached to the stiles and the bases of each pair of adjacent gussets are generally in alignment with one another.

The three pins 121 are connected to a bottom surface of the support bar 117 and extend perpendicularly therefrom. The three pins and are spaced from one another with two of the pins 121 being positioned at opposed distal ends of the support arm and the third pin is centrally located at the curved section 130 of the connector bar. The three pins 121 are generally cylindrical with the centrally located pin having a diameter larger than a diameter of the pins located at the distal ends of the support bar. In one preferred form of the invention, the central pin will have a diameter of 1 inch and the distal pins will have a diameter of ½ inch and all of the pins will be two inches in length. The three pins engage the hatchway 46 with the two short pins contacting an outer surface of the hatchway 46 and the larger pin engaging an inner surface of the hatchway.

The strap 123 has opposed ends connected to one of each of the stiles below the apexes of the gussets, on a front (FIG. 11-13) or back side (FIGS. 7-10) of the stiles and preferably the connection is permanent. The strap 123 is generally arcuate in shape from end to end. The strap 123 can have a variety of shapes in horizontal cross section such as a straight line, a curved line, a C-shape, a D-shape, an H-shape, an L-shape, a V-shape, circular, oval, polygonal, irregular, and sinusoidal. Polygonal shapes include triangular, square, rectangular, trapezoidal, pentagonal, hexagonal, heptagonal, and octagonal. Most preferably, the strap will have a straight line cross sectional shape. The strap 123 is elongate having a length dimension greater than a width dimension and a depth dimension.

FIG. 10 shows another embodiment of a ladder 200 of the present invention that is the same as the ladder described with respect to FIGS. 7-9 but differs in that the ladder 200 can be assembled and disassembled without destroying the ladder. For example, the ladder can be assembled for use and then disassembled for storage. The ladder 200 has a top segment 202, a middle segment 204 and a bottom segment 206. FIG. 10 shows the ladder segments adjacent one another but not connected together. The top segment 202 is connected to the middle segment, for example, at a pair of joints 208. Each of the two joints has a pair of holes, one of each on a stile, that are brought into alignment and a clevis pin is inserted through the holes to secure the segments together. A hairpin cotter is inserted through a bore at a distal end of the clevis pin to retain the clevis pin in place during use of the ladder. Preferably, the holes extend through the entire diameter of the stile. An opposed end of the middle segment 204 is similarly connected to the bottom segment 206. Additional ladder segments are connected in the same fashion.

In an embodiment where the securing assembly 115 is releasably attached to the top segment 202, the securing assembly has two connector tubes (not shown) attached to a bottom surface of the support bar and extend in a perpendicular direction away from the bar. The gussets connect the connector tubes to the support arm instead of to the stiles. A hole at a distal end of each connector tube is brought into alignment with respective holes on a top end of each of the stiles and the parts are releasably connected together using the clevis pin assemblies in the same fashion as the ladder segments are connected as discussed above.

The dimensions of the ladder can vary based on the need and application. Typically, the ladder will have sufficient height to extend from a top of a tank to a bottom surface of a tank to provide safe access by a person using the ladder. The ladder can be stowed, for example, on a tanker truck, service vehicle or in a garage or other storage area.

In a preferred form of the invention, the stiles, arms and rungs will be made from a material suitable for use as a ladder and capable of supporting the weight of an adult person of, for example, 250 pounds, and can include, metal, fiberglass, composite materials, wood, polymeric materials and combinations of the same. Suitable metals include aluminum and steel, and preferably is aluminum. The parts can be manufactured by any suitable method such as extrusion and molding or other technique well known to those of ordinary skill in the art. In one preferred form of the invention, the rungs will have traction enhancing modifications such as a textured surface, knurls 220 and or non-slip paint. FIGS. 8 and 10 show knurls 220 extending along the length of the rungs.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims. The appended claims should be construed broadly and in a manner consistent with the spirit and the scope of the invention herein.

We claim:

1. A portable ladder comprising:
a pair of elongate stiles spaced from one another and each having first and second ends, and extending in a first direction; and
a plurality of rungs each extending between the elongate stiles transverse to the first direction and having opposed ends one of each attached to each of the elongate stiles and each of the plurality of rungs being spaced from one another along the first direction, the rungs being arcuate in shape between the opposed ends.

2. The ladder of claim 1 wherein each of the rungs have a curved section generally centrally disposed between the opposed ends.

3. The ladder of claim 2 wherein the stiles have and outer surface and the curved section extends radially outward beyond the outer surface.

4. The ladder of claim 1 wherein the stiles have a shape in cross section selected from a straight line, a curved line, a letter shape, a C-shape, a D-shape, an H-shape, a T-shape, an L-shape, a V-shape, circular, oval, polygonal, irregular, and sinusoidal.

5. The ladder of claim 4 wherein the polygonal shapes include triangular, square, rectangular, trapezoidal, pentagonal, hexagonal, heptagonal, and octagonal.

6. The ladder of claim 1 further comprising a securing assembly attached to the ladder.

7. The ladder of claim 6 wherein the securing assembly is attached to an end of one of the stiles.

8. The ladder of claim 6 wherein the securing assembly has a portion attached to a top end of each of the stiles.

9. The ladder of claim 6 wherein the securing assembly connects a top end of each of the stiles.

10. The ladder of claim 9 wherein the securing assembly comprises a support bar that connects to a top end of both of the stiles.

11. The ladder of claim 10 wherein the support bar is arcuate in shape and has a generally centrally disposed curved section.

12. The ladder of claim 9 further comprising a pair of gussets one of each gusset connecting the support bar to one of each of the stiles.

13. The ladder of claim 11 wherein the support arm has a plurality of spaced pins extending from a surface of the support bar in a direction generally perpendicular to the support bar.

14. The ladder of claim 13 wherein the plurality of pins includes three pins, two of the pins positioned proximal opposed ends of the support bar and the third pin being centrally disposed on the support bar in the curved section.

15. The ladder of claim 10 further comprising a support strap extending between and attached to both stiles.

16. The ladder of claim 15 wherein the support strap is arcuate in shape.

17. The ladder of claim 11 wherein the support bar has opposed end sections that extend outward beyond the stiles to defines a first mounting flange and a second mounting flange.

18. The ladder of claim 17 wherein the central section extends beyond the stiles and forms a third mounting flange.
